(19) United States
(12) Patent Application Publication
(10) Pub. No.: US 2025/0118857 A1
(43) Pub. Date: Apr. 10, 2025

(54) VEHICLE LOWER PART STRUCTURE

(71) Applicant: TOYOTA JIDOSHA KABUSHIKI KAISHA, Toyota-shi (JP)

(72) Inventor: Koji SAEKI, Oakazaki-shi (JP)

(73) Assignee: TOYOTA JIDOSHA KABUSHIKI KAISHA, Toyota-shi (JP)

(21) Appl. No.: 18/775,177

(22) Filed: Jul. 17, 2024

(30) Foreign Application Priority Data
Oct. 10, 2023 (JP) 2023-175223

(51) Int. Cl. H01M 50/358; B60R 16/04; H01M 50/249; H01M 50/271

(52) U.S. Cl. CPC H01M 50/358; B60R 16/04; H01M 50/249; H01M 50/271; H01M 2220/20

(57) ABSTRACT

The vehicle lower part structure includes a battery disposed at a lower part of the vehicle, a cover member that covers the battery from the vehicle lower side, and a ventilation passage that allows traveling wind to pass between the battery and the cover member and narrows a flow path at the discharge portion relative to other portions.

### CROSS-REFERENCE TO RELATED APPLICATION

This application claims priority to Japanese Patent Application No. 2023-175223 filed on Oct. 10, 2023, incorporated herein by reference in its entirety.

### BACKGROUND

### 1. Technical Field

The present disclosure relates to a vehicle lower part structure.

### 2. Description of Related Art

Japanese Unexamined Patent Application Publication No. 2020-82983 (JP 2020-82983 A) discloses a battery cooling device that, in a structure in which a battery case is located on a lower side of a floor panel, includes a fixing bracket for fixing the battery case to the floor panel, and is provided with a ventilation passage between the fixing bracket and a bottom surface of the battery case, thereby cooling the battery.

### SUMMARY

However, in the battery cooling device described in JP 2020-82983 A, since a sectional area of the ventilation passage except for an inflow portion is constant, there is a case where traveling wind cannot be taken in efficiently, and there is room for improvement in the viewpoint of improving the cooling performance of the battery.

An object of the present disclosure is to obtain a vehicle lower part structure that can improve the cooling performance of a battery.

A vehicle lower part structure according to claim 1 includes a battery, a cover member, and a ventilation passage.

The battery is disposed at a lower part of a vehicle.

The cover member covers the battery from a vehicle lower side.

The ventilation passage is provided between the battery and the cover member to allow traveling wind to pass through, and, in the ventilation passage, a flow path at a discharge portion is narrower than at other portions.

In the vehicle lower part structure according to claim 1, the battery is disposed at the lower part of the vehicle, and the battery is covered from the vehicle lower side by the cover member. Further, the ventilation passage is provided between the battery and the cover member. As a result, the traveling wind can cool the battery by passing through the ventilation passage when the vehicle is traveling.

Furthermore, in the ventilation passage, the flow path at the discharge portion is narrower than at the other portions. This increases the flow rate of the air discharged at the discharge portion, so that more traveling wind can be introduced into the ventilation passage.

In the vehicle lower part structure according to claim 2, in claim 1, the cover member is provided with a plurality of convex beads extending in a vehicle front-rear direction and protruding toward a vehicle upper side, and the ventilation passage is provided between the convex beads adjacent to each other in a vehicle width direction.

In the vehicle lower part structure according to claim 2, since the plurality of convex beads is provided in the cover member, the rigidity of the cover member can be increased. Further, by providing a ventilation passage between the convex beads adjacent to each other, it is not necessary to provide a separate dedicated member. Furthermore, since the convex beads protrude toward the vehicle upper side, interference between the cover member and the road surface can be suppressed as compared to a structure in which concave beads or the like protruding toward the vehicle lower side are provided.

In the vehicle lower part structure according to claim 3, in claim 1, a dimension of the ventilation passage in a vehicle width direction decreases from a vehicle front side toward a vehicle rear side.

In the vehicle lower part structure according to claim 3, since the dimension of the ventilation passage in the vehicle width direction decreases from the vehicle front side toward the vehicle rear side, it is possible to increase the flow rate of the air discharged at the discharge portion without changing a height dimension of the ventilation passage.

In the vehicle lower part structure according to claim 4, in claim 1, a dimension of the ventilation passage in a vehicle up-down direction decreases from a vehicle front side toward a vehicle rear side.

In the vehicle lower part structure according to claim 4, since the dimension of the ventilation passage in the vehicle up-down direction decreases from the vehicle front side toward the vehicle rear side, it is possible to increase the flow rate of the air discharged at the discharge portion without changing a width dimension of the ventilation passage.

In the vehicle lower part structure according to claim 5, in any one of claims 1 to 4, an inflow port of the ventilation passage opens toward a front of the vehicle in front of the battery in a vehicle front-rear direction.

In the vehicle lower part structure according to claim 5, since the inflow port of the ventilation passage is in front of the battery in the vehicle front-rear direction, a front end portion of the battery can be cooled. Further, since the inflow port opens toward the front of the vehicle, it is easy to introduce the traveling wind.

As described above, according to the vehicle lower part structure of the present disclosure, the cooling performance of the battery can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional side view schematically illustrating an entire configuration of a vehicle to which a vehicle lower part structure according to embodiment is applied;

FIG. 2 is a plan view of a cover member in embodiments;

FIG. 3 is a cross-sectional view taken along line 3-3 of FIG. 1;

FIG. 4 is a cross-sectional side view illustrating a vehicle lower part structure according to a modification; and

FIG. 5 is a plan view of a cover member in a modification.

### DETAILED DESCRIPTION OF EMBODIMENTS

The vehicle lower part structure 10 according to the embodiment will be described with reference to the drawings.

### Overall Configuration of Vehicle Lower Part Structure 10

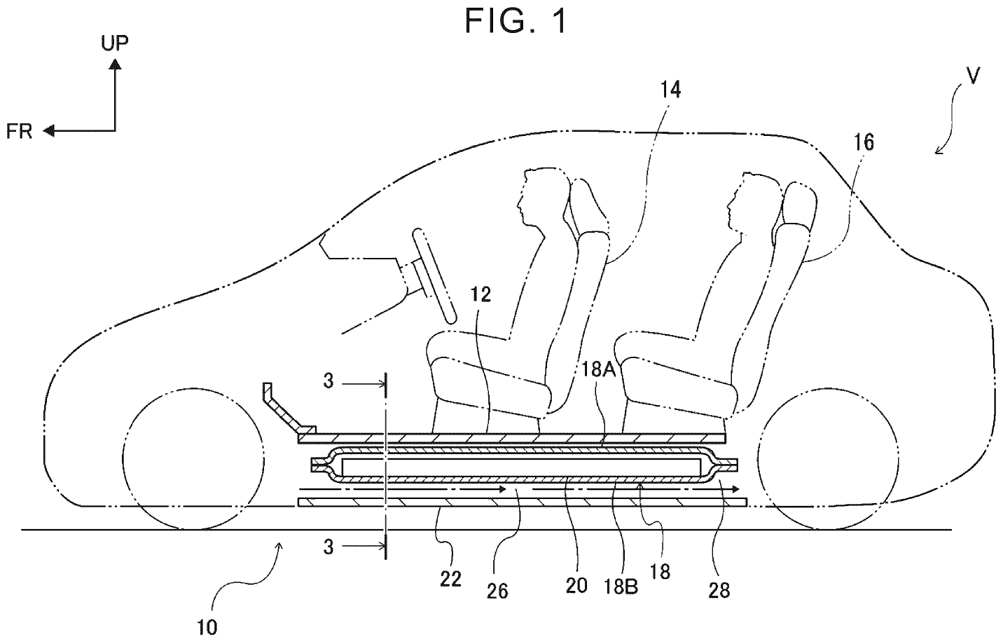

FIG. 1 is a side cross-sectional view schematically illustrating an entire configuration of a vehicle lower part structure 10 according to an embodiment. The vehicle lower part structure 10 of the present embodiment includes a battery 20 disposed in a lower portion of the vehicle V.

The battery 20 is disposed below the floor panel 12 that constitutes the floor surface of the vehicle cabin. The floor panel 12 is a substantially rectangular plate-shaped member that partitions the vehicle cabin interior and the outside of the vehicle cabin interior, and a front seat 14 and a rear seat 16 are provided on the floor panel 12.

The battery 20 is housed in the battery case 18. In the present embodiment, the battery case 18 includes an upper case 18A and a lower case 18B. The lower case 18B is formed in a substantially rectangular plate shape extending in the vehicle front-rear direction and the vehicle widthwise direction, and the battery 20 is disposed on the upper surface of the lower case 18B. Further, the outer peripheral end portion of the lower case 18B is curved upward, and the flanged portion extends outward.

The upper case 18A is formed in a substantially rectangular plate shape extending in the vehicle front-rear direction and the vehicle widthwise direction similarly to the lower case 18B. Further, a flange portion overlapped with the flange portion of the lower case 18B is formed at an outer peripheral end portion of the upper case 18A. The flange portions are mechanically fastened to each other by bolts or the like to form a battery case 18.

A cover member 22 that covers the battery 20 (the battery case 18) from the vehicle lower side is provided on the vehicle lower side of the battery case 18. The cover member 22 may be, for example, an under cover that covers the vehicle body from the vehicle lower side.

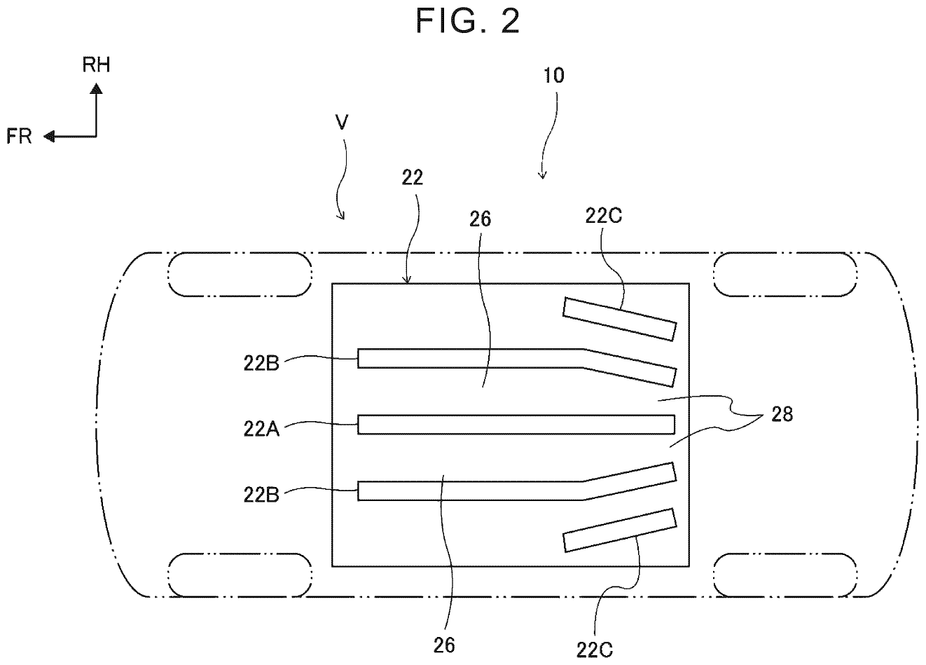

FIG. 2 is a plan view of the cover member 22 according to the embodiment. As shown in FIG. 2, the cover member 22 is formed of a substantially rectangular plate-shaped metal plate extending in the vehicle front-rear direction and the vehicle width direction. Here, in the present embodiment, as an example, the battery 20 is disposed below the floor panel 12 in the entire area in the vehicle width direction, and the cover member 22 is formed in a size capable of covering the entire battery 20 from the vehicle lower side.

Further, the cover member 22 is formed with a plurality of convex beads extending in the vehicle front-rear direction and protruding toward the vehicle upper side. In the present embodiment, as an example, the cover member 22 is formed with a first convex bead 22A, a second convex bead 22B, and a third convex bead 22C.

The first convex bead 22A is formed at a center part of the cover member 22 in the vehicle widthwise direction, and extends in the vehicle front-rear direction. Further, a second convex bead 22B is formed on both sides of the first convex bead 22A in the vehicle width direction. That is, a pair of the second convex bead 22B is formed on the left and right sides of the first convex bead 22A.

The second convex bead 22B extends substantially parallel to the first convex bead 22A except for the rear portion. The rear portion of the second convex bead 22B is inclined inward in the vehicle widthwise direction so as to approach the first convex bead 22A from the vehicle front side toward the vehicle rear side. Therefore, the distance between the first convex bead 22A and the second convex bead 22B is narrowed from the vehicle front side toward the vehicle rear side.

A third convex bead 22C is formed on the vehicle width direction outer side of the second convex bead 22B. The third convex bead 22C is formed on the vehicle width direction outer side of the rear portion in the second convex bead 22B, and is shorter than the first convex bead 22A and the second convex bead 22B. The third convex bead 22C is inclined inward in the vehicle widthwise direction so as to approach the second convex bead 22B from the vehicle front side toward the vehicle rear side.

The first convex bead 22A, the second convex bead 22B, and the third convex bead 22C protrude toward the vehicle upper side, respectively, and the ventilation passage 26 is provided between the convex beads adjacent to each other in the vehicle width direction. That is, the ventilation passage 26 is provided between the first convex bead 22A and the second convex bead 22B. Similarly, a ventilation passage is provided between the second convex bead 22B and the third convex bead 22C. Therefore, the ventilation passage 26 has a smaller dimension in the vehicle width direction from the vehicle front side toward the vehicle rear side. In other words, the flow path at the discharge portion 28 set at the rear end of the ventilation passage 26 is narrower than the other portions.

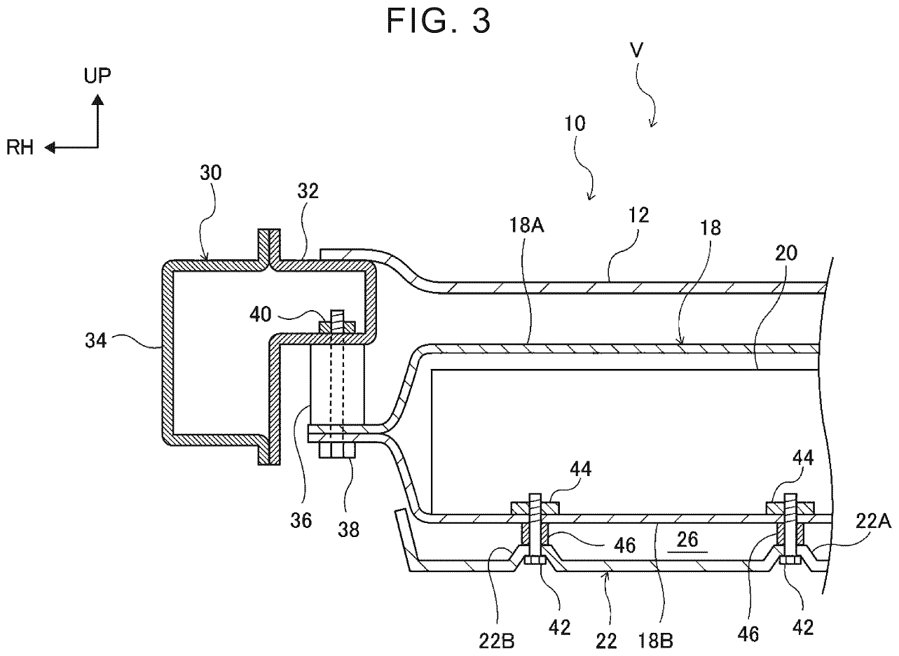

FIG. 3 is a cross-sectional view taken along line 3-3 of FIG. 1. As shown in FIG. 3, in the present embodiment, as an example, the end portion of the battery 20 in the vehicle width direction is fastened to the rocker 30 which is a skeleton member.

The rocker 30 is a skeleton member having a closed cross-section extending in the vehicle front-rear direction, and includes a rocker inner panel 32 on the inner side in the vehicle width direction and a rocker outer panel 34 on the outer side in the vehicle width direction. The rocker inner panel 32 is formed in a substantially hat-shaped cross section having an open outer side in the vehicle width direction, and a flange extends in the vehicle up-down direction.

The rocker outer panel 34 is formed in a substantially hat-shaped cross section having an open inner side in the vehicle width direction, and a flange is formed at a position corresponding to the flange of the rocker inner panel 32. Then, the flanges of the rocker inner panel 32 and the flanges of the rocker outer panel 34 are joined to each other by spot welding or the like in a superimposed state. The rocker 30 may be integrally formed by extruding an aluminum alloy or the like.

A bolt insertion hole (not shown) is formed in an end portion of the battery case 18 in the vehicle width direction, and a bolt 38 is inserted into the bolt insertion hole, and is screwed into a weld nut 40 provided in the rocker inner panel 32. A spacer 36 is provided between the rocker inner panel 32 and the battery case 18.

The cover member 22 has a vehicle widthwise end bent toward the vehicle upper side and extends along the lower case 18B of the battery case 18. The first convex bead 22A and the second convex bead 22B formed in the cover member 22 are fastened to the lower case 18B by bolts 42.

Specifically, bolt holes are formed in the first convex bead 22A and the second convex bead 22B, and the bolt 42 is inserted into the bolt hole from the vehicle lower side. Therefore, the head portion of the bolt 42 enters the concave portion formed by the first convex bead 22A and the concave portion formed by the second convex bead 22B, respectively.

The bolt 42 is screwed into a weld nut 44 provided on the lower case 18B of the battery case 18. A spacer 46 is provided between the first convex bead 22A and the lower case 18B and between the second convex bead 22B and the lower case 18B.

As described above, a gap is provided between the battery case 18 and the cover member 22, and this gap serves as a ventilation passage 26 through which traveling wind can pass. As shown in FIG. 1, the inflow port of the ventilation passage 26 opens toward the front of the vehicle on the vehicle front side of the battery 20.

### Operations

Next, the operation of the vehicle lower part structure 10 according to the present embodiment will be described.

In the vehicle lower part structure 10 according to the present embodiment, the battery 20 is disposed below the vehicle V, and the battery 20 is covered from the vehicle lower side by the cover member 22. A ventilation passage 26 is provided between the battery 20 and the cover member 22. As a result, the traveling wind passes through the ventilation passage 26 during traveling of the vehicle V or the like, so that the battery 20 can be cooled.

In particular, in the present embodiment, since the inflow port of the ventilation passage 26 is closer to the vehicle front side than the battery 20, it is possible to cool down to the front end portion of the battery 20. Further, since the inflow port is open toward the front of the vehicle, it is easier to introduce the traveling wind as compared with a structure for introducing the traveling wind from below the vehicle body.

Further, in the present embodiment, as shown in FIG. 2, the cross-sectional area of the discharge portion 28 of the ventilation passage 26 is smaller than other portions.

This increases the flow rate of the air discharged by the discharge portion 28, so that more traveling wind can be introduced into the ventilation passage 26. In particular, in this embodiment,

Since the dimension of the ventilation passage 26 in the vehicle width direction decreases from the vehicle front side toward the vehicle rear side, the flow rate of the air discharged by the discharge portion 28 can be increased without changing the height dimension of the ventilation passage 26.

Furthermore, in the present embodiment, since a plurality of convex beads 22A, 22B, 22C is formed in the cover member 22, the rigidity of the cover member 22 can be increased. Further, by forming the ventilation passage 26 between adjacent convex beads, it is not necessary to provide a separate dedicated member.

Furthermore, in the present embodiment, since the first convex bead 22A, the second convex bead 22B, and the third convex bead 22C protrude toward the vehicle upper side, the cover member 22 and the road surface can be prevented from interfering with each other by comparing the configuration in which a concave bead or the like protruding toward the vehicle lower side is formed. That is, if the concave bead is formed in the cover member 22, the concave bead protrudes below the general portion of the cover member 22, so that there is a possibility that a gap with the road surface cannot be secured. Further, when the cover member 22 is moved to the vehicle upper side in order to secure a gap with the road surface, there is a possibility that the mounting space of the battery 20 and the vehicle cabin interior space become narrow. On the other hand, in the present embodiment, since only the convex bead protruding toward the vehicle upper side is formed in the cover member 22, cushioning between the cover member 22 and the road surface can be suppressed while securing the vehicle cabin interior space and the mounting space of the battery 20.

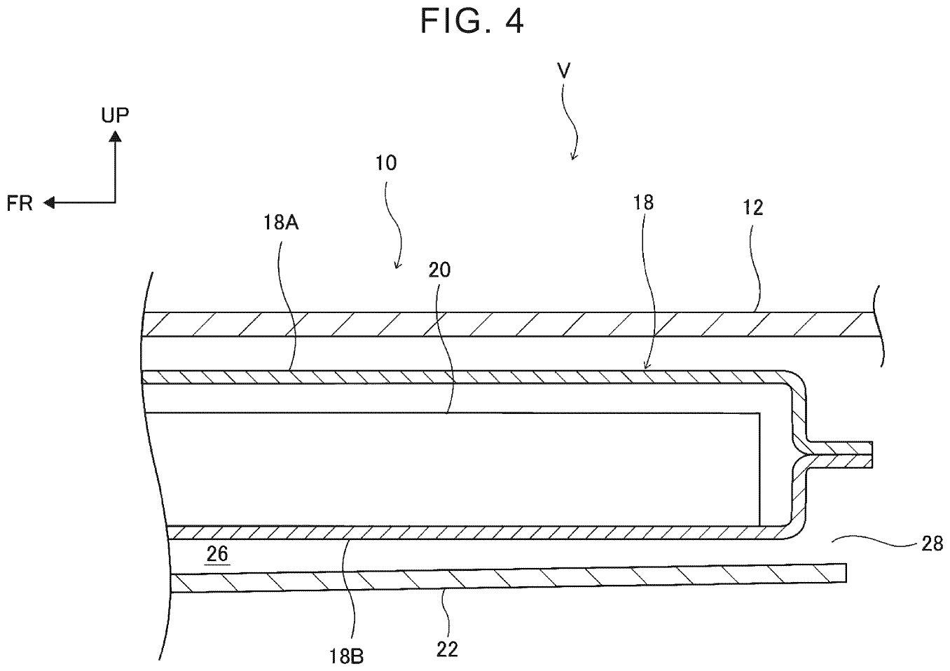

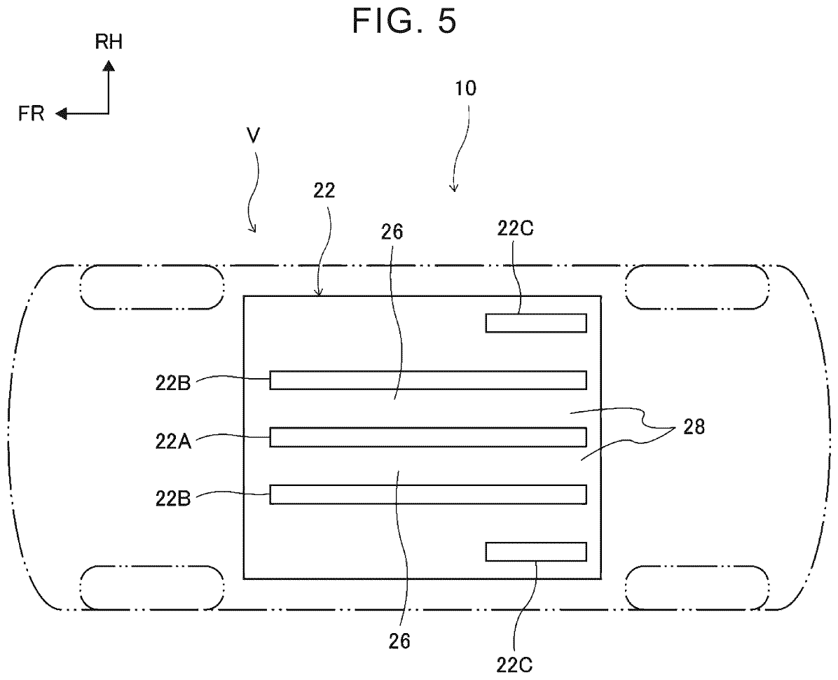

In the present embodiment, as shown in FIG. 1, the gap between the battery case 18 and the cover member 22 is substantially the same from the front portion to the rear portion, but the present disclosure is not limited thereto. For example, the structure of the modification illustrated in FIGS. 4 and 5 may be adopted.

### Modifications

FIG. 4 is a side cross-sectional view illustrating a vehicle lower part structure 10 according to a modification. FIG. 5 is a plan view of the cover member 22 according to the modification. As shown in FIG. 4, the present modification differs from the embodiment in that the cover member 22 is inclined in a side view.

Specifically, a cover member 22 is provided below the battery case 18, and the cover member 22 is inclined so as to be positioned upward from the vehicle front side toward the vehicle rear side. Therefore, the ventilation passage 26 between the battery case 18 and the cover member 22 has a smaller dimension in the vehicle up-down direction from the vehicle front side toward the vehicle rear side.

As shown in FIG. 5, a first convex bead 22A, a second convex bead 22B, and a third convex bead 22C are formed in the cover member 22. The first convex bead 22A is formed at a center part of the cover member 22 in the vehicle widthwise direction, and extends in the vehicle front-rear direction.

The second convex bead 22B is formed on both sides in the vehicle widthwise direction of the first convex bead 22A, and extends in the vehicle front-rear direction substantially parallel to the first convex bead 22A. Therefore, the ventilation passage 26 between the first convex bead 22A and the second convex bead 22B is substantially the same width from the inflow port of the front portion to the discharge portion 28 of the rear portion.

In the present modification, the dimension of the ventilation passage 26 in the vehicle width direction is not changed. However, since the dimension of the ventilation passage 26 in the vehicle up-down direction decreases from the vehicle front side toward the vehicle rear side, as in the embodiment, the flow rate of the air discharged by the discharge portion 28 is increased, it is possible to introduce more traveling wind into the ventilation passage 26.

In this modification, the dimension of the ventilation passage 26 in the vehicle width direction may be made smaller from the vehicle front side toward the vehicle rear side as shown in FIG. 2. In this case, the ventilation passage 26 has a smaller dimension in the vehicle up-down direction and a smaller dimension in the vehicle width direction from the vehicle front side toward the vehicle rear side, so that the flow velocity at the discharge portion 28 becomes larger, and the cooling performance of the battery 20 can be improved.

Although the vehicle lower part structure 10 according to the present disclosure has been described above, it is needless to say that the present disclosure can be implemented in various forms without departing from the gist of the present disclosure. In the above-described embodiment, as shown in FIG. 2, the first convex bead 22A, the second convex bead 22B, and the third convex bead 22C are formed in the cover member 22, and the ventilation passage 26 is provided between the adjacent convex beads, but the present disclosure is not limited thereto. For example, a structure in which a convex bead is not formed in the cover member 22 may be employed. Even in this case, if the cross-sectional area of the discharge portion 28 in the ventilation passage 26 is smaller than the other portions, the cooling performance of the battery 20 can be improved as in the above-described embodiment. As a method of reducing the cross-sectional area of the ventilation passage 26, there is a method of inclining the cover member 22 as shown in FIG. 4. As another method, there is a method of providing a convex bead in the battery case 18 without providing a convex bead in the cover member 22. That is, a convex bead protruding from the lower case 18B of the battery case 18 toward the cover member 22 may be formed, and a ventilation passage may be provided between the convex beads.

In the above-described embodiment, as shown in FIG. 3, the first convex bead 22A and the second convex bead 22B of the cover member 22 are fastened to the battery case 18 by the bolts 42, but the present disclosure is not limited thereto. For example, the general portion of the cover member 22 and the battery case 18 may be mechanically fastened by bolts or the like. The cover member 22 may be mechanically fastened to the lower case 18B at a part extending from both end portions in the vehicle widthwise direction toward the vehicle upper side. Furthermore, both end portions of the cover member 22 in the vehicle width direction may be curved along the lower case 18B to be superimposed on the lower surface of the flange of the lower case 18B, and the cover member 22 may be fastened to the rocker 30 together with the upper case 18A and the lower case 18B by the bolts 38.

With respect to the above embodiments, the following supplementary notes are disclosed.

### Appendix 1

A battery disposed at a lower part of the vehicle;
A cover member for covering the battery from the vehicle lower side,
Between the battery and the cover member, the traveling wind is provided so as to be able to pass, the cross-sectional area of the discharge portion is smaller than the other portions ventilation passage,
A vehicle lower part structure comprising:

### Appendix 2

the cover member is formed with a plurality of convex beads extending in a vehicle front-rear direction and protruding toward a vehicle upper side, and
The vehicle lower part structure according to claim 1, wherein the ventilation passage is provided between the convex beads adjacent to each other in the vehicle width direction.

### Appendix 3

The vehicle lower part structure according to Appendix 1 or 2, wherein the ventilation passage has a smaller dimension in the vehicle width direction from the vehicle front side toward the vehicle rear side.

### Appendix 4

The vehicle lower part structure according to Appendix 1 or 2, wherein the ventilation passage has a smaller dimension in the vehicle up-down direction from the vehicle front side toward the vehicle rear side.

### Appendix 5

The vehicle lower part structure according to any one of 1 to 4, wherein an inflow port of the ventilation passage opens toward a front of the vehicle in front of the battery in a vehicle front-rear direction.

What is claimed is:

1. A vehicle lower part structure comprising:
a battery disposed at a lower part of a vehicle;
a cover member that covers the battery from a vehicle lower side; and
a ventilation passage that is provided between the battery and the cover member to allow traveling wind to pass through, and in which a flow path at a discharge portion is narrower than at other portions.

2. The vehicle lower part structure according to claim 1, wherein:
the cover member is provided with a plurality of convex beads extending in a vehicle front-rear direction and protruding toward a vehicle upper side; and
the ventilation passage is provided between the convex beads adjacent to each other in a vehicle width direction.

3. The vehicle lower part structure according to claim 1, wherein a dimension of the ventilation passage in a vehicle width direction decreases from a vehicle front side toward a vehicle rear side.

4. The vehicle lower part structure according to claim 1, wherein a dimension of the ventilation passage in a vehicle up-down direction decreases from a vehicle front side toward a vehicle rear side.

5. The vehicle lower part structure according to claim 1, wherein an inflow port of the ventilation passage opens toward a front of the vehicle in front of the battery in a vehicle front-rear direction.
